(19) United States
(12) Patent Application Publication
(10) Pub. No.: US 2006/0026127 A1
(43) Pub. Date: Feb. 2, 2006

(54) Method and apparatus for classification of a data object in a database

(75) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/520,199

(22) PCT Filed: Jun. 27, 2003
(86) PCT No.: PCT/IB03/02911

§ 371 Date: Jan. 4, 2005

(30) Foreign Application Priority Data
Jul. 9, 2002 (EP) 02077765.2

(51) Int. Cl. G06F 17/30

(52) U.S. Cl. 707/3

(57) ABSTRACT

Increasing capacity of storage media allows larger databases. This calls for efficient classification methods to enhance retrieval of data objects like pictures and films. Pictures may carry metadata related to date, time and location of creation. This helps retrieval, but combined queries hamper fast search and retrieval because lots of metadata have to be checked. The invention proposes a method of classifying the data objects by associating the data objects with classification parameters. Each classification parameter is associated with a data object when values of one or more metadata parameters fall within a certain range. Advantageous embodiments provide possibilities for automatic classification by extracting criteria for classification from the database itself. This is done by checking similarity between data objects having equal values for the classification parameter. Similarity is based on the values of the metadata related to, for example, creation of the data object.

The invention relates to a method for classification of a data object in a database, the data object having at least one source parameter associated therewith.

The invention also relates to an apparatus for classification of a data object in a database, the data object having at least one source parameter associated therewith, the apparatus comprising a storage device for storing the database, means for receiving data objects, and a central processing unit.

Such a method is known from European Patent application EP-A-0 959 418. This document presents a digital image retrieval system using such a method. The system comprises an image database having a plurality of digital images stored therein, each of said plurality of digital images having at least one of a plurality of parameters associated therewith. The parameters may represent the geographical location of the place where the picture has been taken, the date when the picture has been taken and/or other properties of the image. The images may be retrieved by a direct query, like a given time and date, but also by a ‘mapped query’: entering a query like “evening” can be translated to the time range 5 pm-8 pm.

Also, queries like “summer in New York” may be entered. In that case, parameters for date and geographical location will be checked. For a first parameter, representing the date, all images have to be searched whether the value first parameter is within the period June 21-September 23. For a second parameter, representing the geographical location, all images have to be searched whether the value of the second parameter matches ‘New York’. When the geographical location is represented by coordinates, even two values have to be checked for the range they are in.

Any person skilled in the art will understand that this seriously slows down the image retrieval procedure, especially when a query with multiple variables is inputted.

It is an object of the invention to provide a classification method that reduces search and retrieval time.

This object is achieved by the method according to the invention, by associating a classification parameter with the data object, wherein the classification parameter is associated with the data object when a value of the source parameter satisfies at least one criterion.

In this way, data objects may be classified prior to query and search, and a search may be aimed at one parameter only, the classification parameter. This highly reduces the search time, especially when a query with multiple variables is inputted. This is a major advantage over the prior art.

In an embodiment of the method according to the invention, the database comprises further data objects having at least one further source parameter associated therewith and the method comprises the following steps: identifyig similar further data objects having at least one further classification parameter associated with each similar data object, wherein the classification parameters of the similar further data objects have equal values; identifying similarity of values of the further source parameter of the further similar data objects having equal further classification parameters; and associating the further classification parameter with the data object when the data object is similar to the further data objects.

An advantage of this embodiment is that once a few data objects have been classified, criteria for associating a classification parameter having a predetermined value with a data object—the similarity criteria—can be identified and other data objects can be classified, using this embodiment of the method according to the invention. An advantage of this embodiment is that, in this way, classification of data objects can be automated.

In an embodiment of the method according to the invention, the value of the further classification parameter and the similarity as a criterion for associating a new data object with the further classification parameter with the value are stored in a further database.

By storing criteria for associating a data object with a classification parameter having a predetermined value in a further database like a table, criteria for similarity do not have to be found from the database every time a data object has to be classified. This reduces the time needed for classification of a data object, especially in large databases.

In the apparatus according to the invention, the central processing unit is conceived to associate a classification parameter with the data object when the source parameter satisfies at least one criterion.

An embodiment of the invention is a computer-readable medium, comprising instructions which are, readable and executable by a computer, wherein the instructions enable a computer to execute the method defined in claim 1.

Embodiments of the invention will now be presented by means of Figures in which:

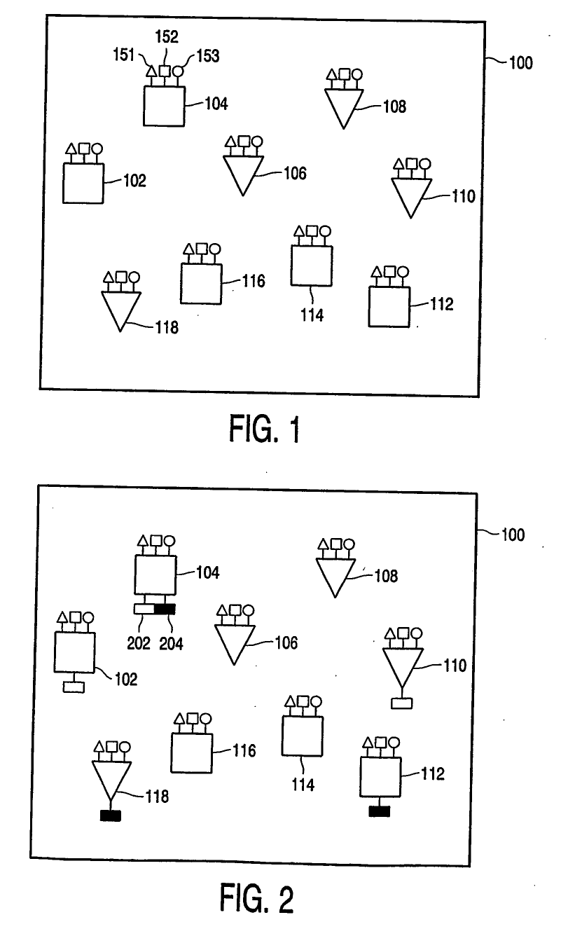

FIG. 1 shows a database comprising data objects having source parameters associated therewith;

FIG. 2 shows a database comprising data objects having source parameters and classification parameters associated therewith;

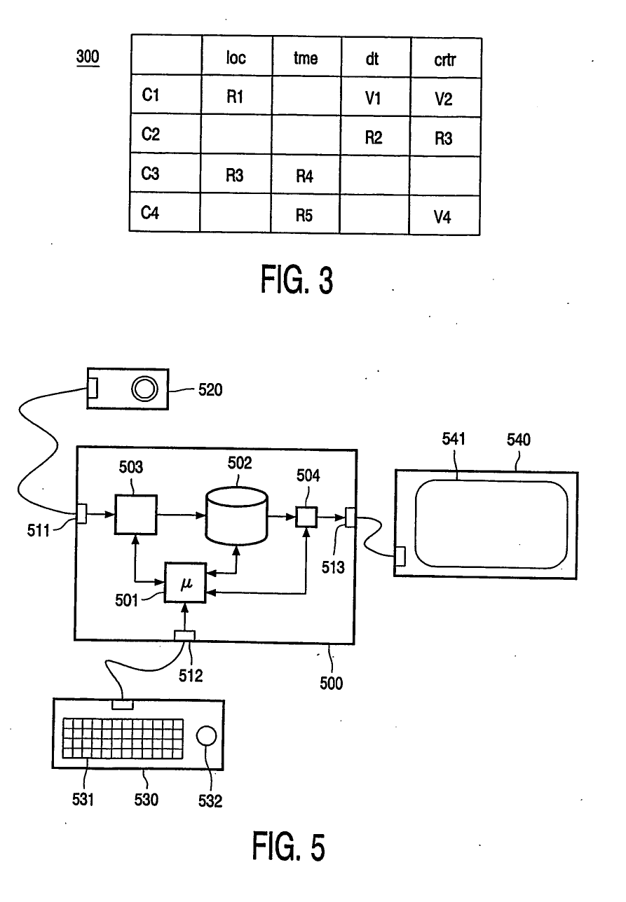

FIG. 3 shows a table comprising criteria for classification of data objects;

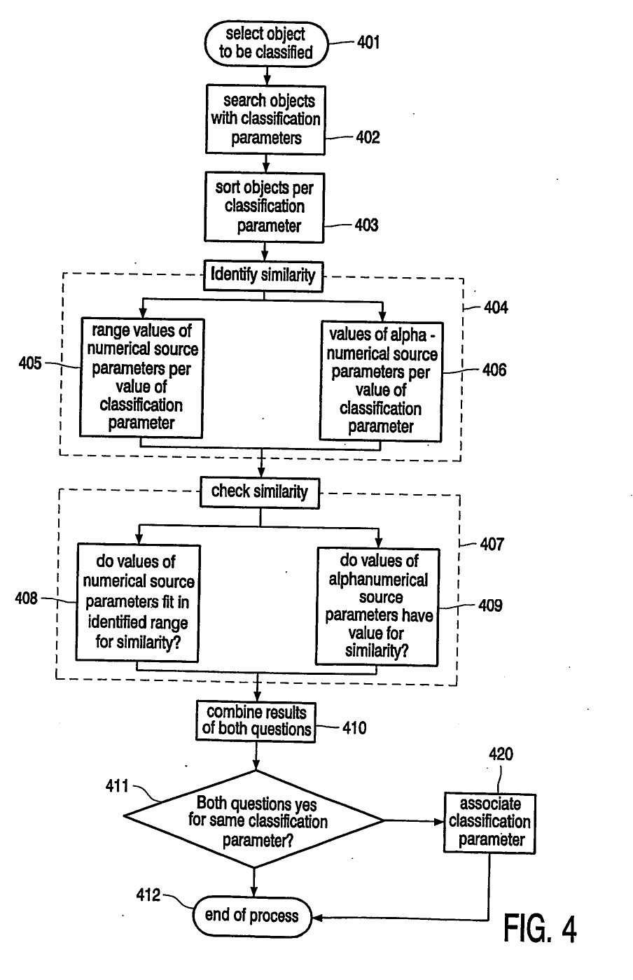

FIG. 4 shows a flowchart depicting an embodiment of the method according to the invention;

FIG. 5 shows an embodiment of the apparatus according to the invention with peripherals;

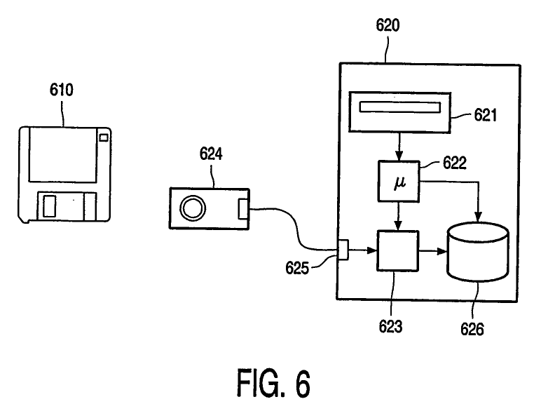

FIG. 6 shows an embodiment of a computer readable medium according to the invention.

FIG. 1 shows a database 100 comprising several data objects 102, 104, 106, 108, 110, 112, 114, 116, 118. This database may be stored in an apparatus to be discussed hereinafter. The data objects 102, 104, 106, 108, 110, 112, 114, 116, 118 may be still picture images, streams of audio-visual data or text documents. Those skilled in the art will appreciate that this list is not limitative. In the embodiment described here, the data objects are still picture images, in particular photos, and streams with audiovisual data. In the Figures, the photos are depicted as large squares, whereas the streams with audio-visual data are depicted as large triangles.

The photos are associated with source parameters, for example, the photo 104 is associated with a first source parameter 151, a second source parameter 152 and a third source parameter 153. The source parameters provide information on the source of the data This information concerns the geographical location of the data object, the date of creation of the data object, the time of creation of the data object, the name of the creator of the data object or the format of the data object, but also other information maybe provided with source parameters. The data format parameter may relate to a compression format (e.g. GIF or JPEG) or to the kind of data (e.g. photo or stream with audio-visual data). In one embodiment of the invention, the source data relates to the content of the data object For I example, a photograph is analyzed by a face analysis program, yielding the names of the people in the picture. Source parameters with the names of the people in the picture are associated with the picture after analysis. For the sake of simplicity, only three source parameters are shown in FIG. 1.

Although the source parameters may very well describe the source of the data object, a single source parameter will not tell very much about the content of the photo or stream. However, the values of a multitude of parameters may very well give an indication about the content of the photo. For example, a picture taken at co-ordinates 53° North, 4° East in April 2001 by someone called Peter may indicate “holiday in Amsterdam”. Therefore, when looking for photos and streams that relate to a special event, a query with several criteria for several source parameters may be run on database 100. However, this may be quite a task, especially when defining the co-ordinates of a specific city or the range of coordinates that indicate a country. Several ideas have been proposed to facilitate the search, e.g. by letting a user define a region by drawing one on a map or by mapping queries, e.g. “summer” to the time period of June 21 to September 22. This may facilitate the search for certain photos, but it requires a lot of processing at the moment of the query, because of all data-objects, four parameters—format, date, location, creator—have to be read and compared. This may require quite some patience from a user.

Therefore, it is proposed to enable a user as well as a system for storing the database 100 to classify photos and streams by associating them with at least one classification parameter. This means that all pictures taken at coordinates 53° North. 4° East in April 2001 by someone called Peter are associated with the parameter “holiday in Amsterdam”. This highly simplifies a search for holiday pictures taken in Amsterdam, because only one parameter, a classification parameter, of all data objects has to be read and compared.

FIG. 2 shows the same data objects as shown in FIG. 1, but in addition to FIG. 1, some of the data objects in FIG. 2 have one or two classification parameters associated with them. A first classification parameter 202 is associated with data objects of format pictures, created in Amsterdam, April 2001, by someone called Peter. A second classification parameter 204 is associated with data objects—irrespective of the data format—created in Europe in the spring of 2001. The reason for this is that association with a classification enhances search possibilities of the database 100. It is easier to check the value of only one classification parameter of all data objects in the database 100 than checking the values of multiple source parameters. Furthermore, it is more convenient for a user to enter a query in a natural language rather than enter a query that specifies the values of one or more source parameters to be in a certain range.

Therefore, to enhance search and retrieval functionality and user friendliness of the database 100, data objects are associated with a predetermined classification parameter—like photos of the holiday trip to China in the summer of 2001—as at least one source parameter matches at least one criterion. In a preferred embodiment, this is done as the data object is entered into the database 100 to reduce processing at a later stage. However, when multiple data objects are entered at once, this may take long because a lot of processing power is taken by the association process. Therefore, in another embodiment, association takes place as a background task after the objects have been entered.

The criteria for one or more values of one or more source parameters of a data object to be satisfied for associating a classification parameter having a certain value with the data object maybe stored in a further database like a table 300 in FIG. 3. The left column of the table 300 states, values of classification parameters. The first row of the table 300 states entities of source parameters. In this embodiment of the invention, the entities are location “loc” of creation of the data object, the time “tme” of creation, the date “dt” of creation and the creator “crtr” of the document.

During the association process, values of source parameters of a data object are compared with the criteria in the table 300. When the location of creation of the data object is within range R1, the date is equal to value V1 and the creator is equal to V2, the data object is associated with a classification parameter having a value C1. As mentioned before, a data object may be associated with more than one classification parameter. When the location of the data object is within range R3 and the time is within range R4, the source parameter is associated with a further classification parameter having a further value C3.

The table 300 may be created by a user. It may also be created by a process that is depicted by means of a flowchart 400 in FIG. 4. This process is an embodiment of the method according to the invention. It is assumed that a database with data objects to be classified already contains classified data objects. These data objects may either be classified by a user or by an apparatus, using, for example, the table 300 as presented in FIG. 3.

The process commences with a process step 401 by selecting a data object to be classified. The process step 401 step may be initiated by entering the data object into the database. Subsequently, in a process step 402, data objects that have already been classified are being searched for. In a process step 403, the data objects already classified are sorted in groups per value of the classification parameter. As stated before, data objects may have multiple classification parameters associated with them. In that case, a data object is sorted in multiple groups.

When the data objects have been grouped per equal value of at least one classification parameter, similarity of data objects with equal values of the classification parameter is identified in a process step 404. The process step 404 comprises two substeps. A substep 405 is executed for numerical source parameters and a substep 406 is executed for alphanumerical source parameters. In the substep 405, the range of values is determined for each numerical source parameter of data objects having equal values of the classification parameter. The range determined in this way is considered a criterion for similarity. In the substep 406, the values of each alphanumerical source parameter are determined. When all values of a certain alphanumerical source parameter have equal values, this value is considered a criterion for similarity.

The next step is a process step 407, which comprises two substeps as well. In the process step 407, it is checked whether the object to be classified is similar to any of the data objects that have already been classified. In a substep 408, it is checked whether the values of the numerical source parameters are within the ranges defined for similarity for those respective source parameters. These ranges have been defined in the substep 405, as already explained. In a substep 409, it is checked whether the values of the alphanumerical source parameters are equal to the values defined for similarity for these respective source parameters. These values have been defined in the substep 406.

In a further embodiment, the value of the alphanumerical source parameter is a word, and synonyms and the word in other languages are also considered to be equal and therefore similar.

In yet a further embodiment of the method according to the invention, the similarity criterion is satisfied when alphanumerical values match by more than a given value, e.g. 90%.

In a process step 410, the results of the substep 408 and the substep 409 are combined. Subsequently, in a decision step 411, it is checked whether all tests of the substep 408 and the substep 409 have positive results, for one classification parameter. This means that all values of all source parameters of the data object to be classified match all criteria for similarity. When this is indeed the case, the data object is associated with a classification parameter whose value is made to match all similarity criteria This is performed in a process step 420. After this, the process is ended in a terminator 412.

When it is detected in the decision step 411 that not all tests of the substep 408 and the substep 409 have positive results, the process is ended in the terminator 412 after the decision step 411.

Various other embodiments of the invention take the embodiment that has just been described as a departure point. In one further embodiment, when checking whether the data object to be classified is similar to data objects already classified, only the values of certain predetermined source parameters are checked instead of the values of all source parameters of the data object to be classified.

In yet a further embodiment of the invention, the criteria for similarity that have been derived in the process step 404 of the flowchart 400 are stored in a table or a database of another form. This table may be set up like the table 300 in FIG. 3. In yet another embodiment of the invention, the flowchart 400 is expanded with a further process step. This process step may be between the process step 401 and the process step 402. In the further process step, the table with criteria for similarity is checked whether there is similarity between a data object to be classified and data objects with a certain value of the classification parameter, whose similarity criteria are already stored in the table. When no similarity is found, the process described by flowchart 400 is continued.

In yet a further embodiment of the invention, criteria for similarity are identified periodically by only performing the process step 404 and updating a table as described in the previous embodiment. As a data object is entered into the database or targeted to be classified otherwise, only the similarity criteria in the table are checked to determine whether and, if so, how the data object should be classified.

In again a further embodiment of the method according to the invention, classification parameters may also be manually associated with data objects. Analogously, a classification parameter may also be manually de-associated with a data object. Manually associating a classification parameter with a data object may initialize the automatic classification procedure, when this data object is the first in a database to be classified. When a classification parameter is de-associated with a data object, this is preferably noted in such a way that a similar data object will not be associated with said classification parameter in the future.

FIG. 5 shows an apparatus 500 as an embodiment of the apparatus according to the invention. The apparatus 500 comprises a central processing unit, CPU 501, a buffer 503, a mass storage device 502, like a harddisk, and a video processor 504. The apparatus 500 further comprises a first connector 511 for receiving data objects, a second connector 512 for receiving user input and a third connector 513 for providing a video signal to a TV-set 540.

The apparatus 500 operates as follows. The buffer 503 receives data objects from a digital photo camera 520 that is connected to the first connector 511. This data object may be a photograph or a stream of audio-visual data In the buffer 503, the source parameters of the data object are read. The results are processed by the CPU 501, which checks whether and, if so, how the data object can be classified. The classification process may be any one of the embodiments of the method according to the invention as described with reference to FIG. 4.

When the data object can be classified on the basis of known similarity criteria, the data object in the buffer 503 is associated with a classification parameter and stored in mass storage device 502.

The classification and storage of data objects created by means of digital photo camera 520 may be processed automatically. However, the classification may also be done by a user using input means 530, comprising a keyboard 531 and a trackball 532. The user input means 530 can also be used for creating similarity criteria for classification by adding data to the table 300 as presented in FIG. 3.

The data objects stored in the mass storage device 502 can be presented on the screen 541 of TV-set 540. A user may select one or more data objects by means of user input means 530 and a Graphical User Interface, GUI, (not shown) presented on the screen 541. Upon selection of a data object stored in mass storage device 502, the data object is loaded in the video processor 504. The video processor 504 processes the data object to provide a signal presentable on the TV-set 540. In this way, the image or audio-visual stream created by means of the digital photo camera 520 can be shown on the screen 541 of the TV-set 540. In further embodiments, the TV-set 540 may be replaced by a remote display, connected to the apparatus 500 via a network.

The queries for data objects stored in the mass storage device 500 may be numerous. For example, a user may input a query to retrieve all photographs taken by herself in Paris in the summer of 2002 by inputting a query to look for classification parameters with matching values. However, the query may be directed to source parameters as well, although of course a search for one value of a classification parameter will take less time than a search for certain values of several source parameters.

As explained, the apparatus 500 is a dedicated apparatus for executing the method according to the invention. In a further embodiment of the invention, the central processing unit of a general purpose calculation unit like a personal computer is programmed to execute the method according to the invention. The instructions to program the central processing unit are stored on a record carrier.

Both are shown in FIG. 6A and FIG. 6B. FIG. 6A shows a floppy disk 610 as an embodiment of the record carrier comprising computer-readable and executable instructions according to the invention. The information on the floppy disk 610 can be read by a personal computer 620 by means of the floppy disk drive 621. The instructions stored on the floppy disk 610 are sent to a central processing unit, CPU 622 via the floppy disk drive 621, to enable the CPU 622 to execute the method according to the invention.

The CPU 622 controls an input buffer 623, to which a digital photo camera 624 may be connected by means of connector 625. In the embodiment presented, the connector and connection between the digital photo camera 624 and the personal computer 620 are of the USB type.

As explained, the instructions on the floppy disk 610, read by the CPU 622, enable the CPU 622 to execute the method according to the invention and classify the data object in the input buffer 623. Information on whether to clarify, and, if so, how to classify the data is stored on a harddisk 626 comprised by the personal computer 620. After the data object is classified or after a decision is taken not to classify because no matching criteria for classification have been found, the data object is stored in the harddisk system 626. From the harddisk system 626, the data object may be retrieved for further use.

The invention may be summarized as follows:

Increasing capacity of storage media allows larger databases. This calls for efficient classification methods to enhance retrieval of data objects like pictures and films. Pictures may carry metadata related to date, time and location of creation. This helps retrieval, but combined queries hamper fast search and retrieval because lots of metadata have to be checked. The invention proposes a method of classifying the data objects by associating the data objects with classification parameters. Each classification parameter is associated with data object when values of one or more metadata parameters fall within a certain range. Advantageous embodiments provide possibilities for automatic classification by extracting criteria for classification from the database itself This is done by checking similarity between data objects having equal values for the classification parameter. Similarity is based on the values of the metadata related to, for example, creation of the data object.

1. A method for classification of a data object in a database, the data object having at least one source parameter associated therewith, by associating a classification parameter with the data object, wherein the classification parameter is associated with the data object when a value of the source parameter satisfies at least one criterion.

2. A method as claimed in claim 1, wherein the classification parameter is associated with the data object when the object is entered into the database.

3. A method according to claim 1, wherein the criterion is that the value of the source parameter is within a predetermined range.

4. A method according to claim 3, wherein the source parameter represents a geographical location of the creation of the data object, and the criterion is that the value of the source parameter is such that the creation of the data object has taken place in a predetermined region.

5. A method according to claim 1, wherein the criterion is that the value of the source parameter equals a predetermined value.

6. A method according to claim 1, wherein the database comprises further data objects having at least one further source parameter associated therewith and wherein the method comprises the following steps:
identiting similar further data objects having at least one further classification parameter associated with each similar data object, wherein the further classification parameters of the similar further data objects have equal values;
identifying similarity of values of the further source parameter of the further similar data objects having equal further classification parameters;
associating the further classification parameter with the data object when the data object is similar to the further data objects.

7. A method as claimed in claim 6, wherein the value of the further classification parameter and the similarity as a criterion for associating a new data object with the further classification parameter with the value are stored in a further database.

8. A method according to claim 7, wherein the method comprises the step of searching the further database to check whether the source parameter of the data object matches at least one criterion stored in the further database.

9. A method according to claim 6, wherein the value of the further source parameter is an alphanumerical string and similarity is identified as the further source parameters having equal values.

10. A method according to claim 6, wherein the value of the further source parameter is a numerical value and the similarity is identified as the further source parameters having their values in a predetermined range.

11. A method according to claim 3, wherein the source parameter represents at least one a of the following entities:
geographical location of the creation of the data object
date of creation of the data object
time of creation of the data object
name of the creator of the data object
data format of the data object

12. A method according to claim 1, wherein the classification parameter corresponds to an event.

13. A method according to claim 1, wherein the data objects are still picture images.

14. A method according to claim 1, wherein the data objects are streams of audiovisual information.

15. A method according to claim 1, wherein the classification parameter is associated with the data object by a user.

16. A method according to claim 1, wherein the criterion is stored in a further database.

17. An apparatus for classification of a data object in a database, the data object having at least one source parameter associated therewith, the apparatus comprising a storage device for storing the database, means for receiving data objects and a central processing unit, wherein the central processing unit is conceived to associate a classification parameter with the data object when the source parameter satisfies at least one criterion.

18. A computer-readable medium, comprising instructions, which are readable and executable by a computer, wherein the instructions enable a computer to execute the method according to claim 1.
